(19) United States
(12) Patent Application Publication
(10) Pub. No.: US 2016/0296086 A1
(43) Pub. Date: Oct. 13, 2016

(54) System, Method, and Device for Urine Detection

(71) Applicant: Rememdia LC

(72) Inventor: Fraser Smith, Salt Lake City, UT (US)

(21) Appl. No.: 14/684,258

(22) Filed: Apr. 10, 2015

(51) Int. Cl. A47K 17/02; A47K 11/12; E03D 13/00; G01N 21/64

(52) U.S. Cl. CPC A47K 17/02; G01N 21/6447; A47K 11/12; E03D 13/005

(57) ABSTRACT

A device for incentivizing hygienic male urination is disclosed having a receptacle configured to receive human liquid waste therein, the receptacle defined by a plurality of sidewalls and a waste collection area in fluid communication with a waste outlet. A light source is disposed about an interior surface of at least one of the plurality of sidewalls, the light source being configured to emit radiation at a frequency ranging from approximately 315 nanometers to 400 nanometers, wherein the light path of the light source is directed at the waste collection area. A second light source is disposed about an exterior surface of at least one of the sidewalls, wherein the second light source is also configured to emit radiation at a frequency ranging from approximately 315 nanometers to 400 nanometers, and wherein the light path of the second light source is directed outside of the receptacle.

### FIELD OF THE TECHNOLOGY

The present technology relates to improved devices, methods, and systems for detecting urine, such as during a urination event. More particularly, the present technology relates to a training tool for training and incentivizing males to contain urine within a waste receptacle while urinating.

### BACKGROUND OF THE TECHNOLOGY AND RELATED ART

Attracting the attention of urinating males to help in toilet training and to aid in keeping toilets, urinals and the surrounding areas clean has long been a desire. Parents, janitors, and others responsible for the cleanliness of the urinals and toilets and the surrounding areas often find unsanitary conditions due to the sloppiness or laziness of males urinating. This problem causes germs to spread and creates many health and hygiene problems. Several approaches have been proposed for motivating males to urinate into a toilet or urinal without urinating on the sides of the urinal or toilet and/or the surrounding floor or wall. Visually interesting items can be caused to float on the water inside of a toilet bowl, and can be configured so as to change their visual appearance and/or to sink when struck by urine. Another approach is to fix objects inside of an existing urinal that will react to pressure, vibration, wetness, and/or warmth by changing color, revealing hidden images, and/or producing sounds when struck by urine. However, the degree of visual interest and variety of stimuli produced by such devices is limited.

Whether dealing with infants or males of other ages, it is believed that the male will direct his urine at a target if one is present. Indeed, males from a young age need little reason to enter into urinating contests with other males when standing in the snow, near the water, or at a high elevation. While some thought has gone into the design of modern urinals in order to eliminate splash back, the urinating male (whether due to intoxication, disinterest, or purposeful availment of an opportunity) continues to urinate in a manner that results in an overall lack of hygiene. It is therefore desirable, and hoped for by those responsible for cleaning toilets and urinals, for improved methods and systems for incentivizing responsible and hygienic urination.

### SUMMARY OF THE INVENTION

In light of the problems and deficiencies inherent in the prior art, the present invention seeks to overcome these by providing methods, devices, and systems for incentivizing hygienic male urination. In accordance with one aspect of the technology, a device for incentivizing hygienic male urination is disclosed comprising a receptacle configured to receive human liquid waste therein, the receptacle defined by a plurality of sidewalls and a waste collection area in fluid communication with a waste outlet. A light source is disposed about an interior surface of at least one of the plurality of side walls, wherein the light source is configured to emit radiation at a wavelength ranging from approximately 315 nanometers to 400 nanometers. The light path of the light source is directed at the waste collection area.

In another aspect of the technology, a device for incentivizing hygienic male urination, comprising a receptacle configured to receive human liquid waste therein, the receptacle defined by a plurality of sidewalls and a waste collection area in fluid communication with a waste outlet. A light source is disposed about an exterior surface of at least one of the sidewalls, wherein the light source is configured to emit radiation at a wavelength ranging from approximately 315 nanometers to 400 nanometers. The light path of the light source is directed outside of the receptacle in the direction of the ground and/or wall surface.

In yet another aspect of the technology, a device for incentivizing hygienic male urination is disclosed comprising a fastener configured to be disposed about a portion of a receptacle, wherein the receptacle is configured to receive human liquid waste therein and is defined by a plurality of sidewalls and a waste collection area in fluid communication with a waste outlet. A light source is coupled to the fastener and oriented within the fastener such that when the fastener is disposed about the receptacle, the light source has a light path directed toward the waste collection area. The light source is configured to emit radiation at a wavelength ranging from approximately 315 nanometers to 400 nanometers.

### BRIEF DESCRIPTION OF THE DRAWINGS

The present technology will become more fully apparent from the following description and appended claims, taken in conjunction with the accompanying drawings. Understanding that these drawings merely depict exemplary aspects of the present technology they are, therefore, not to be considered limiting of its scope. It will be readily appreciated that the components of the present technology, as generally described and illustrated in the figures herein, could be arranged and designed in a wide variety of different configurations. Nonetheless, the technology will be described and explained with additional specificity and detail through the use of the accompanying drawings in which:

FIG. 1 is a perspective view of a waste receptacle in accordance with one aspect of the technology;

FIG. 2 is a perspective view of a waste receptacle in accordance with another aspect of the technology;

FIG. 3A is a top view of a waste receptacle in accordance with one aspect of the technology;

FIG. 3B is a side view of the waste receptacle in FIG. 3A;

FIG. 3C is a cross-sectional view of a waste receptacle in accordance with one aspect of the technology;

FIG. 4 is a perspective view of a waste receptacle in accordance with one aspect of the technology;

FIG. 5 is a perspective view of a light source and a fastener in accordance with one aspect of the technology.

### DETAILED DESCRIPTION OF EXEMPLARY ASPECTS OF THE TECHNOLOGY

The following detailed description of exemplary aspects of the technology makes reference to the accompanying drawings, which form a part hereof and in which are shown, by way of illustration, exemplary aspects in which the technology may be practiced. While these exemplary aspects are described in sufficient detail to enable those skilled in the art to practice the technology, it should be understood that other aspects may be realized and that various changes to the technology may be made without departing from the spirit and scope of the present technology. Thus, the following more detailed description of the aspects of the present technology is not intended to limit the scope of the technology, as claimed, but is presented for purposes of illustration only and not limitation to describe the features and characteristics of the present technology, to set forth the best mode of operation of the technology, and to sufficiently enable one skilled in the art to practice the technology. Accordingly, the scope of the present technology is to be defined solely by the appended claims. The following detailed description and exemplary aspects of the technology will be best understood by reference to the accompanying drawings, wherein the elements and features of the technology are designated by numerals throughout.

There are many types of materials that “luminesce” when exposed to UV light. These materials tend to have rigid molecular structures that contain delocalized electrons (ones that are not associated with any specific atom within the molecule). For example, when a UV light wave hits an object containing substances known as phosphors, those phosphors will naturally luminesce or “glow.” This luminescence is created by the special way these phosphors use the energy from UV light. When a photon from UV light hits the phosphorous material, it causes the electrons to become excited and stray farther from the nucleus than they normally would. When the electron falls back to its normal state, some of the energy is lost in the form of heat. When the UV light wave is reflected back to human eyes, it has less energy and therefore a shorter wavelength. This wavelength is in the visible spectrum.

Some common examples of these types of materials include white paper made after 1950 (when manufactures began adding fluorescent compounds to paper, making it appear whiter), petroleum jelly, tonic water (due to the presence of quinine), and the edges of US currency (an added security feature to help prevent counterfeiting), among many others. Some common vitamins that fluoresce include A, and B vitamins, niacin, thiamine, and riboflavin. Antifreeze, tooth whiteners, and chlorophyl also luminesce when exposed to UV light. With respect to aspects of the current invention, urine luminesces when exposed to UV light. Phosphors, such as those contained in urine, luminesce in the presence of oxygen, with or without UV light, but the light imparts additional energy that make the luminescence more apparent. As used herein, the term “luminescence” may pertain to fluorescence, phosphorescence, and chemiluminescence, as well as to selective absorbance of predefined wavelength regions of the electromagnetic spectrum, such as infrared (IR) and near infrared (NIR). A luminescent composition is one which emits light, which is not derived from the temperature of the emitting body.

In a preferred aspect of the technology described herein, a UV light is employed that propagates light at a wavelength ranging from approximately 315 to 400 nanometers. Other UV lights emit light at wavelengths of light in the mid (290-315 nm) or far (190-290 nm) UV fields but are less desirable because they may cause skin or eye burns. While aspects of the technology direct the field of UV light away from a user's eyes and/or ensure that the light path of the light is not directed at a user's eyes, mid or far UV is still discouraged for use with the current technology in an effort to avoid inadvertent exposure.

Proper disposal of human waste has long been identified as important to the control of disease, unwanted odors and other aesthetic reasons. For as long as there has been a receptacle designated for the disposal of human waste, there has largely been a problem ensuring that the area proximate to the receptacle remains as hygienic as possible. A social aversion has developed with respect to the presence of urine and/or feces due, in part, to efforts to educate persons about public health concerns and proper hygiene. Aspects of the technology described herein are intended to take advantage of the social aversion associated with the presence of urine on urinals, toilets, surrounding areas and the like, or the presence of back and side spatter of urine out of those waste receptacles resulting from improper urination techniques and/or poor design of waste receptacles. Generally speaking, aspects of the present technology employ a light source that emits radiation at a wavelength of light ranging from approximately 315 to 400 nanometers that is disposed about a human waste receptacle. A light path of the light source is directed to (i) an area within the waste receptacle where liquid waste accumulates and/or where a male is apt to urinate, (ii) an area about the perimeter of the receptacle where urine (from back splatter or otherwise) may be seen during or after a urination event, and/or (iii) an area outside the receptacle where urine (from back splatter or otherwise) may be seen during or after a urination event.

It is intended that the present technology be operable with different types of functional attachments or components and compositions with the end result of improved systems, devices, and methods for incentivizing males to urinate in a manner that maximizes containment of the urine within the waste receptacle. Bearing that in mind, aspects of the technology can be broadly described as a system comprising a receptacle configured to receive human liquid waste therein, the receptacle being defined by a plurality of sidewalls and a waste collection area in fluid communication with a waste outlet. A light source is disposed about an interior surface of at least one of the plurality of side walls, wherein the light source is configured to emit radiation at a wavelength ranging from approximately 315 nanometers to 400 nanometers. The light path of the light source is directed at the interior of the waste receptacle. Alternatively, or in combination, the light source is disposed about an exterior surface of at least one of the plurality of sidewalls, wherein the light path of the second light source is directed toward an exterior of the receptacle and/or an area about the exterior of the receptacle such as adjacent walls or floors. The emission of light at this wavelength will allow the male to observe the location of his urine while urinating, including the splatter that may or may not be present. In addition, the technology allows the male's peers that may be waiting to urinate to observe the presence of splatter. In this manner, males may be encouraged to optimize containment of the urine within the waste receptacle.

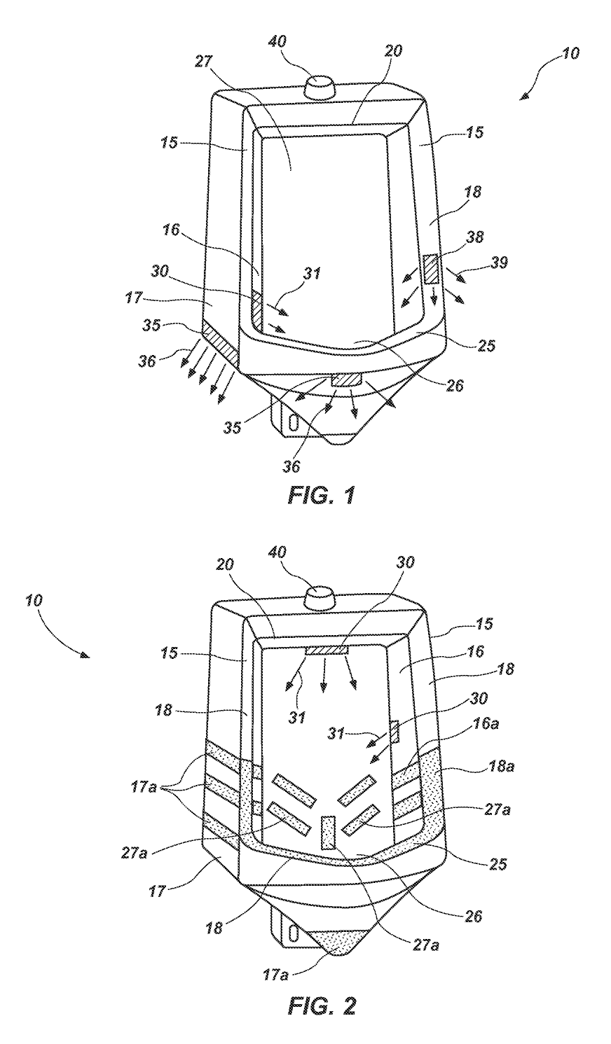

With reference now to the figures, in FIG. 1, in one example aspect of the technology, an example urinal 10 (or liquid waste receptacle) is disclosed defined by a pair of opposing sidewalls 15, a top wall 20, a bottom wall 25 and a water inlet. The bottom wall 25 forms a waste collection area 26 in fluid communication with a waste outlet. Together with a back wall 27, the top 20, bottom 25, and side walls 15 define the area into which the male is intended to urinate. In one aspect of the technology, the waste collection area 26, extends outward from the back wall 27 a greater distance than the top 20 and sidewalls 15 in order to provide an additional area for urine to be trapped prior to being disposed of. The urinal 10 is made of porcelain or other material as is known in the art. It is noted herein that the urinal 10 described herein and shown in the drawings, is merely exemplary. Indeed, those skilled in the art will recognize that other urinal configurations or receptacles intended to receive human waste are contemplated to be applicable to the technology described herein.

A light source 30 is disposed about an interior surface 16 of at least one of the plurality of side walls 15. The light source 30 is capable of and configured to emit radiation at a wavelength ranging from approximately 315 nanometers to 400 nanometers (also known as the UVa range of ultraviolet light). The light path 31 of the light source 30 is directed generally towards the inside of the urinal 10 and, in accordance with one aspect of the technology, at the waste collection area 26. Light source 30 causes urine within its light path 31 to luminesce.

In accordance with an additional aspect of the technology, a light source 35 is disposed about an exterior surface 17 of at least one of the sidewalls 15. The light source 35 about the exterior 17 of the side walls 15 is also capable of and configured to emit radiation at a wavelength ranging from approximately 315 nanometers to 400 nanometers. However, the light path 36 of the light source 35 is directed outside of the urinal 10. Additional light sources 38 can be disposed about a top portion 18 (or rim) of the sidewalls 15 to propagate light thereon. The light path 39 of light source 38 can be directed towards the top 18 of the sidewalls 15 and/or the interior and/or exterior of the urinal 10. Advantageously, the different light paths 31, 36, 39 of the varied lights 30, 35, 38 permits males to view the direction of their splatter or misdirected urine in real time during a urination event.

The placement of lights 35 about an exterior of the urinal 10 also includes placement such that the light path 36 of the light source 35 is directed beneath the urinal 10 towards the ground, walls, or a combination of those. In one aspect of the technology, pluralities of light sources can be disposed about the exterior or interior of the urinal 10. Non-limiting examples of light sources include a light emitting diode, an incandescent bulb, a fiber optic assembly, and any combination of these. It is understood that the light sources may be located within the structure of the urinal 10 itself and/or secured to an exterior of the urinal 10 as suits a particular purpose.

Employing one or more combination of the light sources discussed above, and their associated light paths, allows males to be more aware during a urination event. For example, they are able to view the path of their urine in real-time. They are also able to view pre-existing splatter or misdirected urine from those who have used the urinal 10 before them. Viewing these can make them more conscious of their own urination event, and can motivate them try to ensure that they minimize or prevent splatter or misdirection of their own urine.

In accordance with one aspect of the technology, a sensor 40 is disposed about the urinal 10 operative with one or more light sources 30, 35, 38 and is capable of and configured to activate the one or more of the light sources 30, 35, 38 upon the detection of a person within the field-of-view of the sensor 40. In accordance with one aspect, the sensor 40 is directly coupled to one or more light sources 30, 35, 38 through power cables. However, in another aspect, the light sources 30, 35, 38 can be indirectly coupled to the sensor 40 through a radio transmitter assembly as is known in the art. That is, the sensor 40 can be capable of and configured to send a radio signal to one or more of the light sources 30, 35, 38 wherein the light sources 30, 35, 38 are capable of and configured to be activated or deactivated based on the presence of the user. The light sources 30, 35, 38, can be interconnected to a single power source or can be individually powered by way of a battery, for example. In another aspect of the technology, the sensor 40 is configured to detect the emission of urine from the male and turn on light sources 30, 35, 38 upon the beginning of a urination event. One or more sensors may be used to detect the presence of the user and/or the beginning of (or continuation of) a urination event.

In accordance with one aspect of the technology, the surface of the urinal 10 can comprise a material adapted to absorb wavelengths of light ranging from approximately 315 to 700 nanometers. A non-limiting example includes black composite stone material. Composite stone refers generally to materials composed of a binder and appropriate stone or synthetic aggregates that, when mixed together, form a semi-liquid or paste consistency that can be placed in a mold to make flat, two-dimensional plates for use as tiles or sheets, or three-dimensional objects such as the waste receptacles described herein. The mixture is then cured by an appropriate method to a hardened, unfinished state where the surface can then be ground to reveal the decorative qualities below the rough surface. Different three-dimensional objects are widely produced in several areas of the world and are variously known as composite stone, agglomerated stone, manmade stone, polymer cement or terrazzo.

In yet another aspect, the urinal 10 can comprise a material adapted to absorb wavelengths of light ranging from 315 nanometers to 700 nanometers that is disposed atop a surface of the urinal 10. A non-limiting example includes a black-colored synthetic pressure-sensitive tape applied to a top surface of the urinal 10. The black surface absorbs wavelengths of light in the visible spectrum (400 nanometers to 700 nanometers) as well as those wavelengths of light in the UVa spectrum (315 nanometers to 400 nanometers). Advantageously, urine that is subject to the light waves from one or more light sources 30, 35, 38 luminesces and, against a black background, is more readily apparent to the eye of the urinating male or his peers standing in line. While white surfaces have been conventionally used as an indicator of when receptacles require cleaning, the entire surface need not be black. Intermittent spaces of white surfaces may be present as a general indicator of the need for cleaning. For example, alternating horizontal or vertical stripes of black and white materials may be used to create the desired effect. These can be in many forms designed to be applied to existing urinals, or they can be incorporated into the design of new urinals.

Referring now to FIGS. 1 and 2, in one aspect of the technology, the urinal 10 has one or more surfaces, shown generally at 50, comprising a material that absorbs wavelengths of light ranging from approximately 315 to 700 nanometers. The material can be disposed about different surfaces as suits a particular design. Non-limiting examples include a top portion 18a of sidewalls 15, interior portions 16a of sidewalls 15, exterior portions 17a of the sidewalls 15 and/or portions of the back wall 27a. In one aspect of the technology, a substantial portion of the back wall 27 is covered with said black material with only a target-shaped area showing in white (or some other color within the visible spectrum). In one aspect, the target-shaped area is disposed in the waste collection area 26 and is submerged beneath existing water within the area. While specific reference of a target-shaped area is referenced, it is understood that numerous shapes and designs may be used to incentivize males to urinate in the area that luminesces under the UV light. Moreover, numerous different designs or combinations of absorptive/non-absorptive surfaces about sidewalls 15 (top, interior, and/or exterior) may be used as suits a particular application.

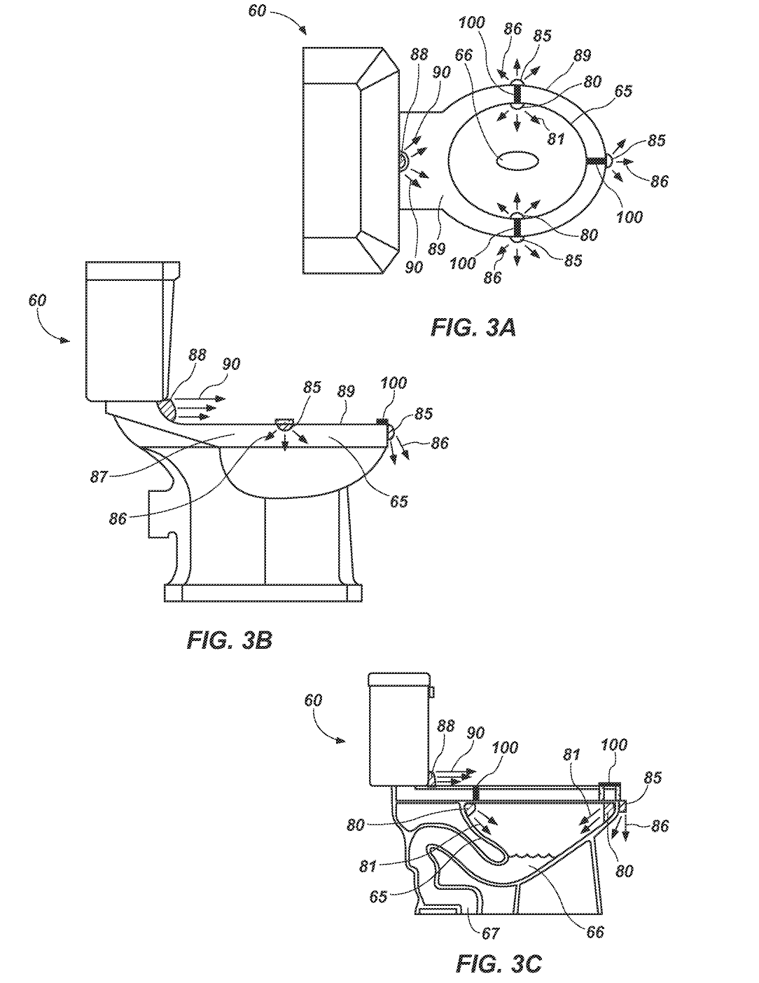

With reference to FIGS. 3A through 3C, in accordance with one example aspect of the technology, a toilet 60 (or liquid waste receptacle) is disclosed having sidewalls 65, a bottom wall 70, and a water inlet. The bottom wall 70 and bottom portion of sidewalls 65 form a waste collection area 66 in fluid communication with a waste outlet 67. Together with a bottom 70 and side walls 65, an area is defined to receive waste, such as the urine from a male. If the male chooses to urinate into the toilet 60 while in a standing position, a likelihood of urine splatter or spilling is increased. In accordance with one aspect of the invention, a light source 80 is disposed about an interior surface of at least one of the side walls 65. The light source 80 is capable of and configured to emit radiation at a wavelength ranging from approximately 315 nanometers to 400 nanometers (also known as the UVa range of ultraviolet light). The light path 81 of the light source 80 is directed generally towards the inside of the toilet 60 and, in accordance with one aspect of the technology, at the waste collection area 66. As with the example of the urinal above, light source 80 causes urine within its light path 81 to luminesce.

In accordance with an additional aspect of the technology, a light source 85 is disposed about an exterior surface 87 of at least one of the sidewalls 65. The light source 85 about the exterior 87 of the side walls 65 is also capable of and configured to emit radiation at a wavelength ranging from approximately 315 nanometers to 400 nanometers. However, the light path 86 of the light source 85 is directed outside of the toilet 60. Additional light sources 88 can be disposed about a top portion 89 (or rim) of the sidewalls 65 or other portions of the toilet 60 to propagate light thereon. The light path 90 of light source 88 is directed towards the top of the sidewalls 65 and/or the interior and/or exterior of the toilet 60.

With reference to FIG. 5, a fastener 100 is disclosed and is capable of and configured to be disposed about a sidewall of a toilet rim or urinal. The fastener 100 comprises a light source 105 capable of and configured to emit radiation at a wavelength ranging from approximately 315 nanometers to 400 nanometers. As used herein, the term “fastener” means any device used to mechanically secure a light source to a portion of a human waste receptacle (e.g., a urinal or a toilet), including, without limitation, clamps, clips, and hooks. The device may be permanently or temporarily (e.g., selectively removable) secured to the receptacle. The device is permanently secured to the receptacle if it is unable to be removed without plastically deforming or destroying the fastening means. Otherwise, the device can be impermanently or removably secured. The light 105 may also be permanently or impermanently secured to the fastener 100 and may be powered by a battery or directly coupled to a remote power source. In one aspect of the invention, a plurality of lights 105 may be mounted to a single fastener 100 as suits a particular purpose. For example, a fastener 100 may be configured such that upon being mounted on the rim of the toilet, a light source 105 is located both about the interior and the exterior of the toilet or anywhere urine is apt to appear about the area of the receptacle. In this aspect, the light source 105 may be in direct contact with the interior or exterior walls of the toilet or may be proximate to the sidewalls as suits a particular purpose. In any event, the light path 106 of the light source 105 is directed to an area intended to cause urine to luminesce, be it splatter about the edges or outside of the toilet or a direct urine stream within the interior of the toilet. The fastener 100 allows existing receptacles to be retrofit with aspects of the present technology so that the benefits of the current technology may be realized without the need to install new receptacles. Alternatively, the fastener 100 may be used with new receptacle installations as a less costly alternative to placement or incorporation of light sources 105 within the structure of the receptacle itself. It is understood that the fastener 100 disclosed herein is one of many devices contemplated for securing a light source 105 to a portion of a human waste receptacle and is not limiting in any way. Indeed, a variety of fasteners or tools may be used to couple one or more light sources to a toilet without departing from the spirit of the technology described herein. In accordance with one aspect of the technology, the light source 105 can comprise a shield disposed about a top of the light source 105. The shield functions to limit the light path 106 of the light source 105 in an upward direction with respect to the ground surface. In this manner, inadvertent exposure to UVa radiation is minimized.

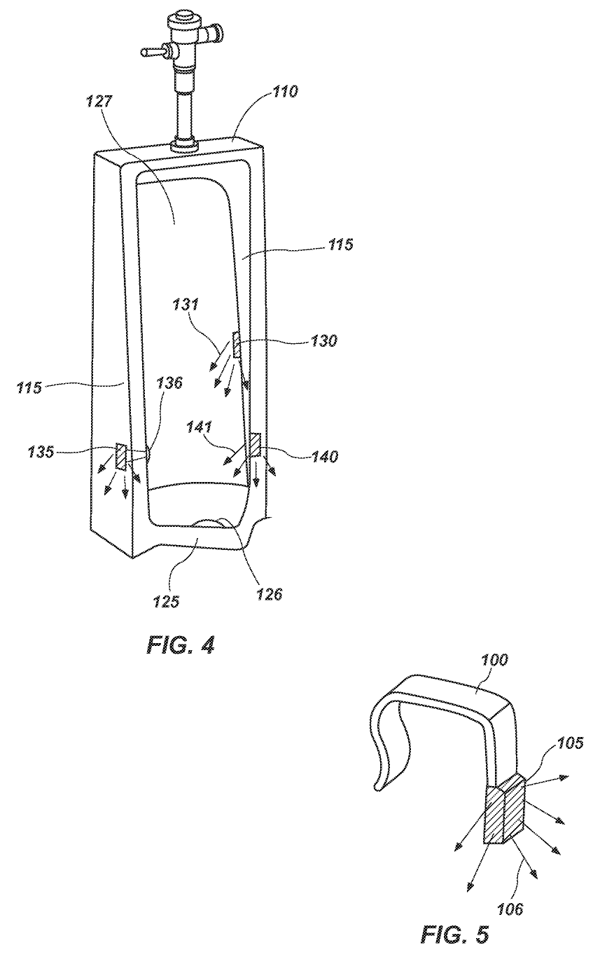

With reference now to FIG. 4, in accordance with another example aspect of the technology, a urinal 110 is disclosed that terminates at ground level. The urinal 110 is defined by a pair of opposing sidewalls 115, a top wall 120, and a bottom wall 125 and a water inlet. The bottom wall 125 forms a waste collection area 126 in fluid communication with a waste outlet. Together with a back wall 127, the top 120, bottom 125, and side walls 115 define the area 126 into which it is intended for a male to urinate. A light source 130 is disposed about an interior of sidewalls 115 with a light path 131 directed toward and interior of the urinal 110. A light source 135 is disposed about an exterior of the urinal 110 having a light path 136 directed toward an exterior of the urinal 110 and/or the wall or floor proximate to the urinal 110. A light source 140 is disposed about a top portion or rim of the urinal 110 having a light path 141 directed toward, one or more of the rim, interior, or exterior of the urinal 110.

Methods of using the above-referenced devices and/or methods and systems intended to incentivize hygienic male urination are contemplated herein. For example, in one aspect of the technology, a method for incentivizing hygienic male urination is disclosed comprising the step of providing a receptacle configured to receive human liquid waste therein, said receptacle being defined by a plurality of sidewalls and a waste collection area in fluid communication with a waste outlet. The method further comprises facilitating the propagation of light toward the waste collection area, wherein the wavelength of the light ranges from approximately 315 nanometers to 400 nanometers. Of course, liquid waste is removed from the receptacle. In another aspect of the technology, the method further comprises the step of detecting the presence of a user in the field-of-view of a sensor disposed about the receptacle and activating a light source disposed about the receptacle in response to the detection of the presence of the user. The step of disposing of waste left in the receptacle and deactivating the light source when the presence of the user is no longer detected by the sensor is also contemplated. In one aspect of the technology, the step of activating a second light disposed about the receptacle is contemplated, wherein the second light has a light path directed outside of the receptacle and wherein the light source is configured to emit radiation at a wavelength ranging from approximately 315 nanometers to 400 nanometers. In an additional aspect, a surface of the receptacle comprises a material configured to absorb wavelengths of light ranging from approximately 315 to 700 nanometers thus improving the ability to view urine spatter about the receptacle.

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

1. A device for incentivizing hygienic male urination, comprising:
a receptacle configured to receive human liquid waste therein, the receptacle defined by a plurality of sidewalls and a waste collection area in fluid communication with a waste outlet; and
a light source disposed about an interior surface of at least one of the plurality of sidewalls, wherein the light source is configured to emit radiation at a wavelength ranging from approximately 315 nanometers to 400 nanometers, wherein the light path of the light source is directed at the waste collection area.

2. The device of claim 1, further comprising a second light source disposed about an exterior surface of at least one of the sidewalls, wherein the second light source is configured to emit radiation at a wavelength ranging from approximately 315 nanometers to 400 nanometers, wherein the light path of the second light source is directed outside of the receptacle.

3. The device of claim 1, wherein the receptacle comprises opposing sidewalls and wherein the light source comprises a plurality of lights secured to the interior surface of the opposing sidewalls.

4. The device of claim 2, wherein the receptacle comprises opposing sidewalls and wherein the second light source comprises a plurality of lights secured to the exterior surface of the opposing sidewalls.

5. The device of claim 1, wherein the light source is selected from the group consisting of a light emitting diode, an incandescent bulb, a fiber optic assembly, and any combination of these.

6. The device of claim 1, wherein the light source is disposed about a top sidewall of the receptacle.

7. The device of claim 1, wherein the light source is disposed proximate the waste collection area.

8. The device of claim 2, further comprising a sensor disposed about the receptacle operative with the first and second light sources and configured to activate the first and second light sources upon the detection of a person within the field-of-view of the sensor.

9. The device of claim 1, wherein a surface of the receptacle comprises a material adapted to absorb wavelengths of light ranging from 400 nanometers to 700 nanometers.

10. The device of claim 1, further comprising a material adapted to absorb wavelengths of light ranging from 400 nanometers to 700 nanometers disposed atop a surface of the receptacle.

11. The device of claim 1, further comprising a sensor disposed about the receptacle operative with the light source and configured to activate the light source upon detection of urine being propagated towards the receptacle.

12. A device for incentivizing hygienic male urination, comprising:
a receptacle configured to receive human liquid waste therein, the receptacle defined by a plurality of sidewalls and a waste collection area in fluid communication with a waste outlet; and
a light source disposed about an exterior surface of at least one of the sidewalls, wherein the light source is configured to emit radiation at a wavelength ranging from approximately 315 nanometers to 400 nanometers and wherein the light path of the light source is directed outside of the receptacle in the direction of the ground surface.

13. The device of claim 12, further comprising a second light source disposed about an interior surface of at least one of the plurality of sidewalls, wherein the second light source is configured to emit radiation at a wavelength ranging from approximately 315 nanometers to 400 nanometers, wherein the light path of the second light source is directed at the waste collection area.

14. The device of claim 12, wherein the light source is disposed beneath the receptacle above the ground surface, the light path of the light source being directed at the ground surface.

15. The device of claim 13, wherein the first and second light sources comprise a shield disposed about a top of the light source limiting the light path of the light source in an upward direction with respect to the ground surface.

16. A device for incentivizing hygienic male urination, comprising:
a fastener disposed about a portion of a receptacle, wherein the receptacle is configured to receive human liquid waste therein and is defined by a plurality of sidewalls and a waste collection area in fluid communication with a waste outlet; and
a light source supported by the fastener and oriented such that when the fastener is disposed about the receptacle, the light source has a light path directed about the receptacle, wherein the light source is configured to emit radiation at a wavelength ranging from approximately 315 nanometers to 400 nanometers.

17. The device of claim 16, wherein the light path is directed toward the waste collection area.

18. The device of claim 16, further comprising a second light source supported by the fastener, such that when the fastener is disposed about the receptacle, the light source has a light path directed about the receptacle in a downward direction.

19. The device of claim 18, wherein the first and second light sources are operative with a sensor disposed about the receptacle, said sensor configured to activate the first and second light sources upon the detection of a person within a field-of-view of the sensor.

20. The device of claim 16, wherein the fastener is configured to couple to the sidewall of the receptacle.

21. The device of claim 16, wherein the fastener comprises a plurality of light sources removably disposed about the fastener.

22. The device of claim 16, wherein the fastener is configured to be removably coupled to the sidewall of the receptacle.

23. A method for incentivizing hygienic male urination comprising:
providing a receptacle configured to receive human liquid waste therein, said receptacle being defined by a plurality of sidewalls and a waste collection area in fluid communication with a waste outlet; and
facilitating propagation of light about the receptacle, wherein the wavelength of the light ranges from approximately 315 nanometers to 400 nanometers.

24. The method of claim 23, further comprising detecting the presence of a user in a field-of-view of a sensor disposed about the receptacle.

25. The method of claim 24, further comprising activating a light source disposed about the receptacle in response to the detection of the presence of the user.

26. The method of claim 23, further comprising activating a second light disposed about the receptacle, wherein the second light has a light path directed about the receptacle, wherein the second light source is configured to emit radiation at a wavelength ranging from approximately 315 nanometers to 400 nanometers.

27. The method of claim 23, providing a surface of the receptacle with a material configured to absorb wavelengths of light ranging from approximately 315 to 700 nanometers, thus improving the ability to view urine spatter about the receptacle.

28. The method of claim 24, further comprising activating a light source disposed about the receptacle in response to the detection of fluid being propagated towards the receptacle.
